(19) United States
(12) Patent Application Publication
(10) Pub. No.: US 2025/0315230 A1
(43) Pub. Date: Oct. 9, 2025

(54) SOFTWARE ARCHITECTURE FACILITATING EXTENSION DEVELOPMENT FOR AN EXTENSION RUNTIME ACCESSED BY A BASE APPLICATION

(71) Applicant: SAP SE, Walldorf (DE)

(72) Inventors: Stephan Lange, St. Leon-Rot (DE); Nico Haefele, Waghäusel (DE); Konrad Koschel, Heidelberg (DE); Eugen Resch, Rauenberg (DE); Thomas Salvador, Östringen (DE); Jay Barbhaiya, Heidelberg (DE)

(73) Assignee: SAP SE, Walldorf (DE)

(21) Appl. No.: 18/629,395

(22) Filed: Apr. 8, 2024

(51) Int. Cl. G06F 8/41

(52) U.S. Cl. CPC G06F 8/443

(57) ABSTRACT

The present disclosure provides techniques and solutions for facilitating the creation of application extensions, including in an extension environment that provides improved extension execution. An interface or model for an application extension can be provided. The extension can represent a particular point in an application's processing where extensions, if present, can be called. The interface or model specifies general features for the extension, such as arguments that are provided when an extension is called or return values that may be expected in response to extension execution. The interface or model can also specify functionality of the base application that an extension implementation can call during its execution. Thus, guidance is provided to developers in writing extension implementations, facilitating their development. The extension implementation, and optionally other code, such as the model, can be compiled for use in an extension runtime.

### FIELD

The present disclosure generally relates to software development and program execution. Particular embodiments provide a software architecture that can be used to develop extension implementations that can be accessed in an extension runtime by a base application.

### BACKGROUND

The are many instances where a software provider provides a core software product that has substantial functionality that is desired by many users. However, a given user, such as a business entity, may desire to customize the core software product in various ways, such as to add or change functionality, to integrate with other software of the users, or to use data structured in a particular manner (or a particular implementation of semi-structured or unstructured data). In some cases, a particular entity may customize software for their individual needs, while in other cases the software provider, or another software provider (e.g., a third-party developer) may develop customizations that are beneficial to multiple users.

The process of customizing a software product can be very time consuming and technical. Further, customizations can involve security risks, as well as having performance and interoperability issues. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques and solutions for facilitating the creation of application extensions, including in an extension environment that provides improved extension execution. An interface or model for an application extension can be provided. The extension can represent a particular point in an application's processing where extensions, if present, can be called. The interface or model specifies general features for the extension, such as arguments that are provided when an extension is called or return values that may be expected in response to extension execution. The interface or model can also specify functionality of the base application that an extension implementation can call during its execution. Thus, guidance is provided to developers in writing extension implementations, facilitating their development. The extension implementation, and optionally other code, such as the model, can be compiled for use in an extension runtime.

In one aspect, the present disclosure provides a process of creating and executing an extension implementation in an extension runtime. An extension implementation is received that provides an implementation of at least one extension point specified in an interface or model. The extension implementation is compiled to provide a compiled extension implementation and the compiled extension implementation is deployed to an extension runtime. During execution of a base software application, the at least one extension point is triggered. In response to the triggering of the at least one extension point, the compiled extension implementation is executed.

The present disclosure also includes computing systems and tangible, non-transitory computer-readable storage media configured to carry out, or includes instructions for carrying out an above-described method. As described herein, a variety of other features and advantages can be incorporated into the technologies as desired.

### BRIEF DESCRIPTION OF THE DRAWINGS

FIG. 1 is a diagram of a computing environment where a base application can communicate with an embedded, or integrated, extension runtime.

FIG. 2 is a diagram of a computing environment where a base application can communicate with a separate extension runtime.

FIG. 3 is a diagram of an example code structure, or software architecture, which can be used in implementing disclosed techniques.

FIGS. 4A and 4B provide example code for an extension interface.

FIGS. 5A and 5B provide example code for a model that can be used by an extension and referenced by the extension interface.

FIG. 6 provides example code for an exit implementation.

FIG. 7 provides example code providing metadata describing the exit implementation of FIG. 6.

FIG. 8 provides example code for a base application that triggers an exit that can cause the execution of the exit implementation of FIG. 6.

FIG. 9 is a diagram of a computing environment where disclosed techniques can be used to develop and execute extensions to be triggered on events associated with data objects.

FIG. 10 is a flowchart of a process of creating and executing an extension implementation in an extension runtime.

FIG. 11 is a diagram of an example computing system in which some described embodiments can be implemented.

FIG. 12 is an example cloud computing environment that can be used in conjunction with the technologies described herein.

### DETAILED DESCRIPTION

### Example 1)—Overview

The are many instances where a software provider provides a core software product that has substantial functionality that is desired by many users. However, a given user, such as a business entity, may desire to customize the core software product in various ways, such as to add or change functionality, to integrate with other software of the users, or to use data structured in a particular manner (or a particular implementation of semi-structured or unstructured data). In some cases, a particular entity may customize software for their individual needs, while in other cases the software provider, or another software provider (e.g., a third-party developer) may develop customizations that are beneficial to multiple users.

The process of customizing a software product can be very time consuming and technical. Further, customizations can involve security risks, as well as having performance and interoperability issues. Accordingly, room for improvement exists.

As particular examples, software products can have many APIs or similar functionality for interacting with the software application. While a software company may be comfortable allowing external parties to access some APIs, ones intended to be public, but in some cases it may not be possible to strictly restrict access to other APIs.

As for performance issues, in some cases an extension runs in the same execution environment as the “base” software application. Thus, code for an extension is not isolated from the base application code. If an extension develops an issue, such as crashing, it can affect the operation of the base software application. Base software applications can include mission-critical software for conducting operations of an enterprise, such as Enterprise Resource Planning (ERP) software.

A further issue is that, because of the interdependence of a base software application and extensions, users may be reluctant to upgrade/update the base application because of concerns whether their extensions will be compatible with the new version of the base software.

Tight integration of a software application and its extension can also limit how extensions can be implemented. For example, if a base application is written in a particular programming language, extensions may also have to be written in that programming language. This can make extension development more difficult, and make extensions less portable.

On the other hand, while a looser coupling between a base application and an extension can address some of the issues noted above, these types of implementations can have other issues. For example, looser coupling may result in a less seamless experience for users, as it may appear that they are using a single application rather than multiple applications. The looser coupling may also lead to less performant extensions, which can be particularly problematic if an extension is used repeatedly, particularly in a short period of time.

Existing technologies for extensions can also make it difficult to provide extensions to multiple users, including multiple tenants in a multi-tenant system. For example, rather than simply purchasing access to a developed extension immediately, a user may need to contact a particular vendor and contract with them for access to an extension.

Disclosed techniques can address these and other issues with existing extension technologies. For example, disclosed techniques can specify particular APIs or other functionality of a base software application that can be used for extensions. This can make the overall application more secure, as well as helping extension developers by more clearly specifying what functionality should be modified/implemented to develop a particular extension.

Extensions can be activated for specific tenants of a multi-tenant environment and, more generally, users can more easily purchase and activate extensions. For example, the more secure nature of the extensions provided by the present disclosure can help users feel more secure in enabling an extension, since there is a reduced risk of it negatively affecting the functionality of the base application, and possibly other extensions already in use. Further, in some cases, extensions can be deployed to an extension environment and then selectively activated for particular users, rather than performing separate deployments for each user. Configuration information can be maintained so that it can be determined whether a particular user is authorized to access a particular extension.

Improved security can be provided at least in part by running extensions in a sandboxed environment. Since the extension is running in a sandbox, issues that affect the performance of an extension, including an extension crashing, can be isolated from the base application. For example, the memory used for an extension can be isolated from memory used by the base application. Through the sandboxed environment, the amount of computing resources that can be used by the extension can be limited.

Another advantage of disclosed technologies is that extensions can be executed with low latency, providing improved performance. In some cases, the extension runtime can act as a library module, and so there is no communication overhead for interactions between the base application and an extension. In other cases, the extension runtime can be executed as a “sidecar,” where the extension has a separate runtime from the base application, but the base application can rapidly communicate with the extension runtime using an appropriate connector and interprocess communications.

Further, extensions can be used frequently, and disclosed techniques can allow for caching of extensions to further enhance performance.

Generally, techniques of the present disclosure execute extensions in a sandboxed environment or using portable binary code. The extension execution environment is generally referred to as an extension runtime. In particular, the disclosure proceeds with the specific example of extensions compiled for execution in a WebAssembly environment, but techniques can be adapted for other types of environments.

Disclosed techniques allow extensions to interact with a base application during the execution of an extension. For example, the base application can provide particular API methods, referred to as callbacks, which can be executed by the extension. This functionality allows for asynchronous communication between the base application and the extension, where the extension can request that the base application perform operations, but the base application continues execution without waiting for such requests.

Another advantage of disclosed techniques is that they allow for code to be developed in different language, but seamlessly used together. For example, at least certain code from a base application and extension-specific code can be compiled to a common format, such as WebAssembly, even if there were written in a different programming language. In general, any suitable programming language can be used in the development/implementation of extensions, provided that a compiler is available to convert the code to the common executable format.

### Example 2)—Example Computing Environment with Integrated Extension Runtime

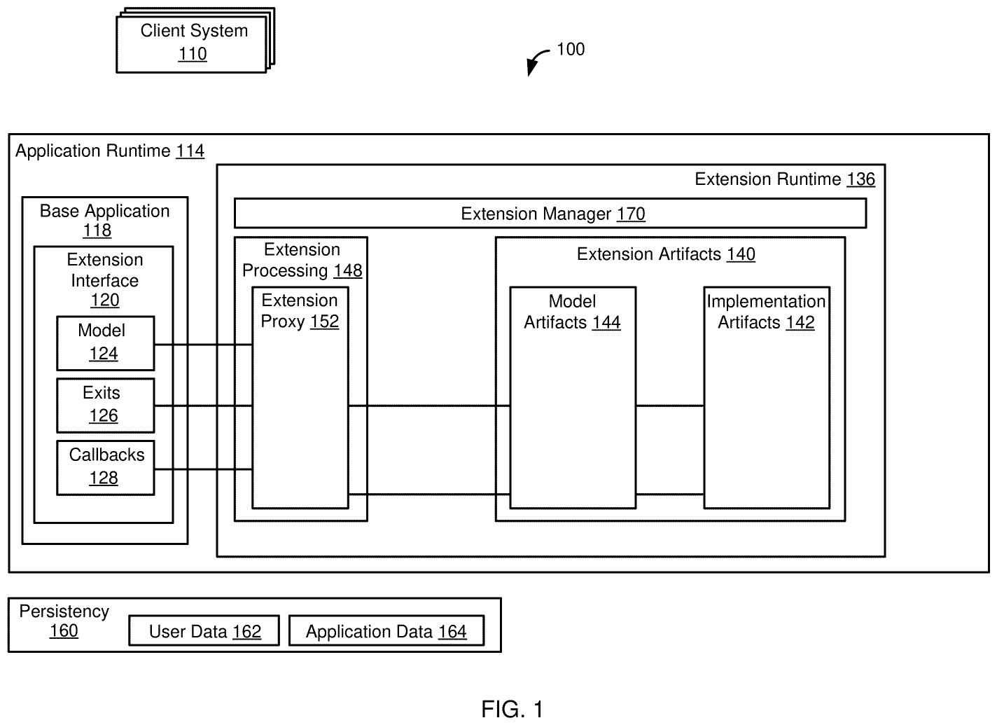

FIG. 1 illustrates an example computing environment 100 in which disclosed techniques can be implemented. The computing environment 100 includes one or more client computing systems 110 that are in communication with an application runtime 114. The application runtime 114 can represent a runtime of a base application 118, for which one or more extensions are provided.

The base application 118 provides an extension interface 120, where the extension interface facilitates the deployment and execution of extensions to functionality of the base application. The extension interface 120 provides a standardized way for extensions to be developed and be deployed. In particular, the extensions can be developed for the interface, and associated code can then be compiled for use in an extension runtime 136.

The extension interface 120 includes a model 124. The model 124 includes information such as data structures, such as definitions of tables or views, which are available for use by an extension. The model 124 also defines exits that may be implemented and APIs 128 (such as callback APIs) that are available for use in such implementations. The interface 120, including through the model 124, can define information such as information that is passed when an exit is called/triggered, and any return that is expected from the implementation. Similarly, the callback APIs 128 can specify what arguments are accepted by the corresponding methods and what return values are provided after the callback is executed. An extension can implement the extension interface 120, including providing implementations for exits 126. The extension implementation can use the callback APIs 128 to access functionality of the base application 118. In the case of WebAssembly, exits 126 can correspond to WebAssembly export functions, while callbacks APIs 128 can correspond to WebAssembly import functions.

Implementations of the exits 126 can then be deployed as implementation artifacts 142 of extension artifacts 140 in the extension runtime 136. The model 124 can also be deployed in the extension runtime 136, as model artifacts 144 for use as part of the extension artifacts 140.

The extension runtime 136 includes extension processing 148. The extension processing 148 includes an extension proxy 152. The extension proxy 152 mediates communications between the base application 118 and the extension artifacts 140. For example, the extension proxy 152 can be responsible for executing an exit implementation of the implementation artifacts 142 when an exit is reached during the processing of the base application 118. Similarly, the extension proxy 152 can forward callback requests made by an implementation artifact 142 during execution of the exit implementation.

In performing these operations, the extension proxy 152 can convert messages and data between formats used by the base application 118 and by the extension runtime 136/extension artifacts 140. For example, the extension proxy 152 can interconvert values between different datatypes used by the base application 118 and the extension runtime 136/extension artifacts 140. Messages can be passed between the extension runtime 136 and the base application in a format such as JSON.

In performing processing, including processing of callback requests, or receiving information provided by an exit implementation, the base application 118 can access information, such as user data 162 or application data 164, in a persistency 160. The persistency can store information in data structures defined in the model 124.

The extension runtime 136 can include an extension manager 170. The extension manager 170 can be responsible for executing extension artefacts 140 when appropriate for use by the base application 118. The extension manger 170 can perform other functions, such as activating extensions as available for use or for caching extensions. Caching extensions can be useful when an extension might be called multiple times over a comparatively short time period.

The extension manager 170, or another component, such as the extension proxy 152, can also perform version management functions. For example, when a request is received to execute an extension implementation, the extension manager 170 can determine a version of the extension implementation to be executed. In some cases, the base application 118 can be mapped to a specific version of an extension implementation, including by having the extension interface 120 be versioned, where the appropriate extension implementation can be selected based on the version of the extension interface 120. In other scenarios, particular users may be associated with different versions of the extension interface 120, or versions of the exit implementation, and this information can be used to select the appropriate extension implementation to execute.

As described, in some cases multiple users, such as users of the client systems 110, can access the extension runtime 136. In a similar manner as version management functions are performed, the extension manager 170, or another component, such as the extension proxy 152, can be responsible for mediating access to particular implementation artifacts 136 depending on whether a user is authorized to access an implementation artifact.

### Example 3—Computing Environment with Separate Extension Runtime

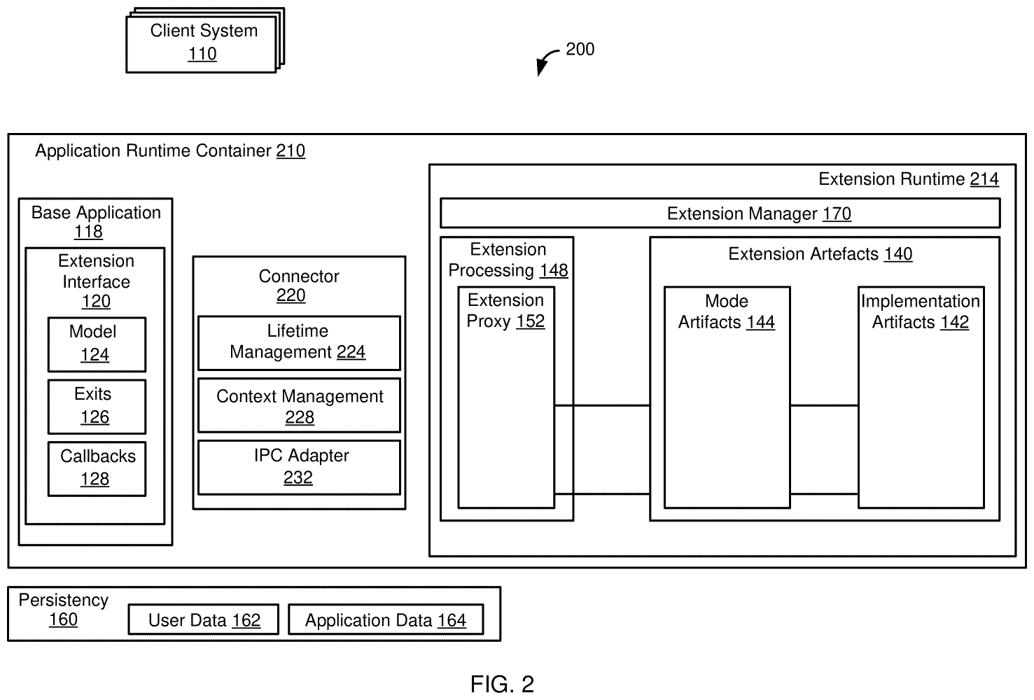

FIG. 2 illustrates another example computing environment 200 in which disclosed techniques can be implemented. The computing environment 200 includes similar components as the computing environment 100 of FIG. 1, where FIG. 2 maintains the reference numbers introduced in the discussion of FIG. 1 for elements of FIG. 1 that are relevant to the computing environment 200.

One difference between FIGS. 1 and 2 is that, in FIG. 1, the application runtime 114 includes both the base application 118 and the extension runtime 136. In FIG. 2, an application runtime container 210 includes the base application 118 and an extension runtime 214 acting as a “sidecar.” The presence of the extension runtime 214 as a sidecar provides for a looser coupling between the base application 118 and an extension runtime. For example, the computing environment 200 can be useful when the base application 118 and the extension runtime 214 are in different programming languages, or, for example, the base application is written in a programming language that is less integrated with a programming language used by the extension runtime 214. In particular, the computing environment 100 can be useful when the base application 118 is programmed in JavaScript, as JavaScript provides support for WebAssembly as the extension runtime 136.

To facilitate communication between the base application 118, having its own runtime, and the extension runtime 214, the base application includes an extension runtime connector 220. The runtime connector 220 includes a lifecycle management component 224. The lifecycle management component 224 can be used to perform functions such as initiating a child process for an extension, setting up communications (such as interprocess communications) with the extension runtime 214, and terminating the child process and communication channel when appropriate. That is, the child process can be a process of the base application 118, and the child process can include its own runtime environment, including its own memory space, resources, and execution context. The lifetime management 224 component can thus help isolate extension execution from execution of the base application 118, reducing chances of “issues” with the extension affecting the base application.

The runtime connector 220 also includes a context management component 228. The runtime connector 220 can concurrently handle multiple extension processes for the base application 118, including for multiple users. Thus, for example, when an exit triggers the execution of an extension, the context management component 228 can assign a context to that exit extension execution “instance.” The context can include information such as an identifier of a user associated with the instance, and optionally additional information such as a user role, permission, preferences, or session information. The context can also include information about the state of the base application 118, such as details about a current “transaction” associated with the exit instance. Among other things, the context information can be used when processing a callback from the execution of implementation artifacts 142 in the extension runtime 214.

The runtime connector 220 includes an interprocess communication adapter 232. The interprocess communication adapter 232 can convert, for example, function calls from the base application 118 to a suitable format for use by the extension runtime 214. These calls can then be processed by the extension proxy 146, in a similar manner as described above for FIG. 1. Similarly, calls from the extension runtime 214, including through the extension proxy 142, can be processed into a format used by the base application. In a particular example, the interprocess communication adapter 232 can interconvert calls expressed in a format used by the base application 118, such as in a particular computing language, to a platform independent or serialized format, such as JSON. In this regard, the runtime connector 220 can be configured for a particular platform, such as a computing language, of the base application 118, and different runtime connector implementations can be used depending on the nature of the base application.

### Example 4—Example Extension Software Architecture

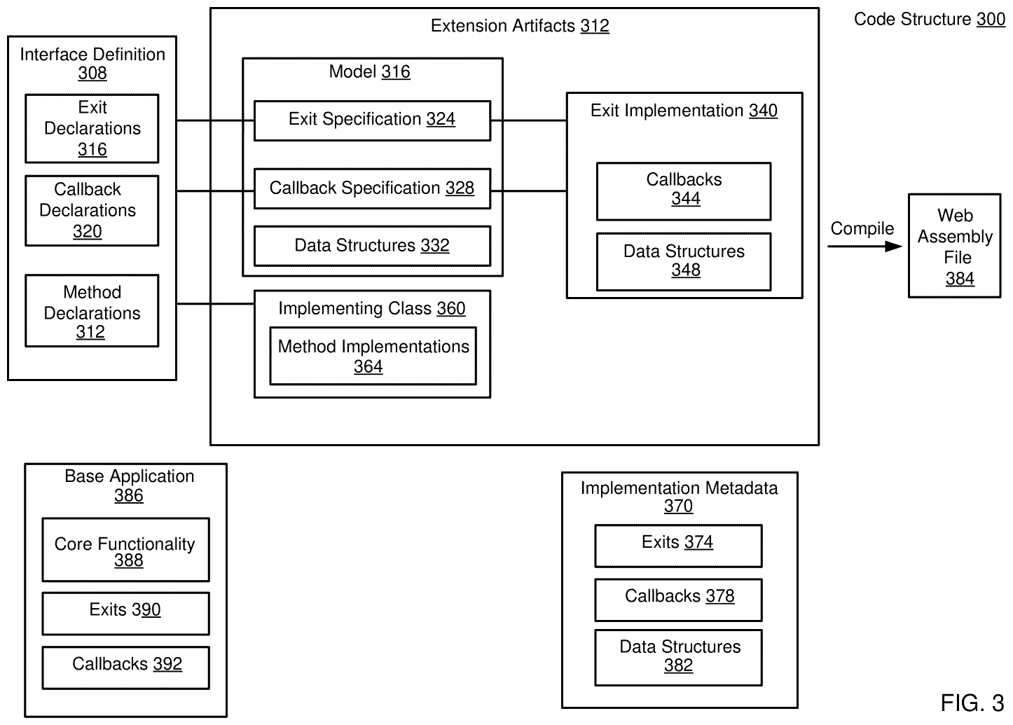

FIG. 3 provides is a diagram of a code structure 300 (which can also be referred to as a software architecture) that can be used to implement disclosed techniques. The code structure 300 includes an interface definition 308, which can be defined with respect to a model 316 that serves as a particular extension artifact of extension artifacts 312 that will be compiled for, and deployed to, the extension runtime. The interface definition 308 includes method declarations 312 of methods that an implementing class is to specify.

The interface definition 308 also include exit declarations 316 and callback declarations 320. Exits (which can more generally be referred to as “hooks” or customization points) declared by the exit declarations 316 define points in a computing process where a user or another developer can add custom functionality to a base application 386. For example, assume the base application 386 includes functionality for processing an order. The exit declarations 316 could include a declaration of an exit where functionality can be carried out before order processing. The exit declaration 316 can include information such as parameters that are provided when the exit is called, or one or more return values that are expected from an exit implementation. Callbacks exposed by the callback declarations 320 can, as described, correspond to functionality of the base application that can be accessed by an extension implementation, and the callback declarations 320 can include information about arguments that should be provided when a callback is called or one or more return values provided by a callback.

In some cases, the exit declarations 316 and callback declarations 320 can correspond to exit specifications 324 and callback specifications 328 of the model 316. In other cases, the exit declarations 316 and callback declarations 320 can be different from the exit specifications 324 and the callback specifications 328. In addition, the exit specifications 324 and the callback specifications 328 may not correspond to exit declarations 316 or the callback declarations 320, but rather declare additional exits or callbacks.

In some cases, additional details about exits of the exit declarations 316 can be provided in the exit specification 324, such as details about how an exit in the exit declarations 316 should be implemented. And, as noted, the exit specifications 324 can, in some cases, provide additional exits that are available for a particular use scenario. That is, the interface definition 308 may include exits, declared by the exit declarations 316, that are useable in a more generic set of circumstances, while the exit specification 328 can declare additional exits that are available in a more specific scenario/type of processing.

Similarly, additional details about callbacks of the callback declarations 320 can be provided in the callback specification 328, where the callback specification can, in a similar manner as the exit specification, provide additional details about how a callback should be used. The callback specification 328 can also specify additional callbacks available for a more specific scenario/type of processing beyond callbacks included in the interface definition 308 through the callback declarations 320.

Additional details for the exits and callbacks provided in the exit specification 324 or the callback specification 328 can include comments that describe the purpose of the exit or callback, particular parameters that should be passed (including types and expected values), and conditions that should be satisfied before or after the execution of the exit or callback. The details can also include details regarding how error or exceptions can be handled.

The model 316 also includes definitions of any data structures 332 (such as relational database tables or views, or similar types of computing objects) that can be used in implementing an exit.

An exit implementation 340 implements at least a portion of the exit declarations 316 or the exit specifications 324, and can use callbacks 344 provided by the callback declarations 320 or the callback specifications 328. Similarly, the exit implementation 340 can include data structure functionality 348, such as functionality to access/manipulate the data structures 332 provided by the model 316. The callbacks 344 can be used by the exit implementation 340 to call particular functionality of the base application 386. For example, the exit implementation 340 might call functionality of the base application 386 to retrieve data or to create a data object (such as a class instance) in the base application, or to update the data of a data structure 232.

The method declarations 312 can be implemented by an implementing class 360, as method implementations 364.

Implementation metadata 370 can be defined for the exit implementation 340. The implementation metadata 370 can provide information about exits 374 that are implemented by the exit implementation 340, callbacks 378 that are used by the exit implementation, and data structures 382 that are used by the exit implementation.

Particular computing structures of the code structure 300 can be compiled to a modules/files/artifacts used in an extension runtime. For example, when the extension runtime is WebAssembly, the extension artifacts 312 can be compiled to a WebAssembly file 384.

A base application 386 includes core functionality 388, and defines exits 390 and callbacks 392, which can correspond to exits and callbacks used by other components of the code structure 300. The base application 386 can be linked to the extension implementation 340 using the implementation metadata 370. For example, the base application 386 can use the implementation metadata 370 to determine what extension implementation should be used, or the base application can be configured to use a particular exit implementation, such as when multiple exit implementations are available.

### Example 5—Example Implementation of Software Architecture

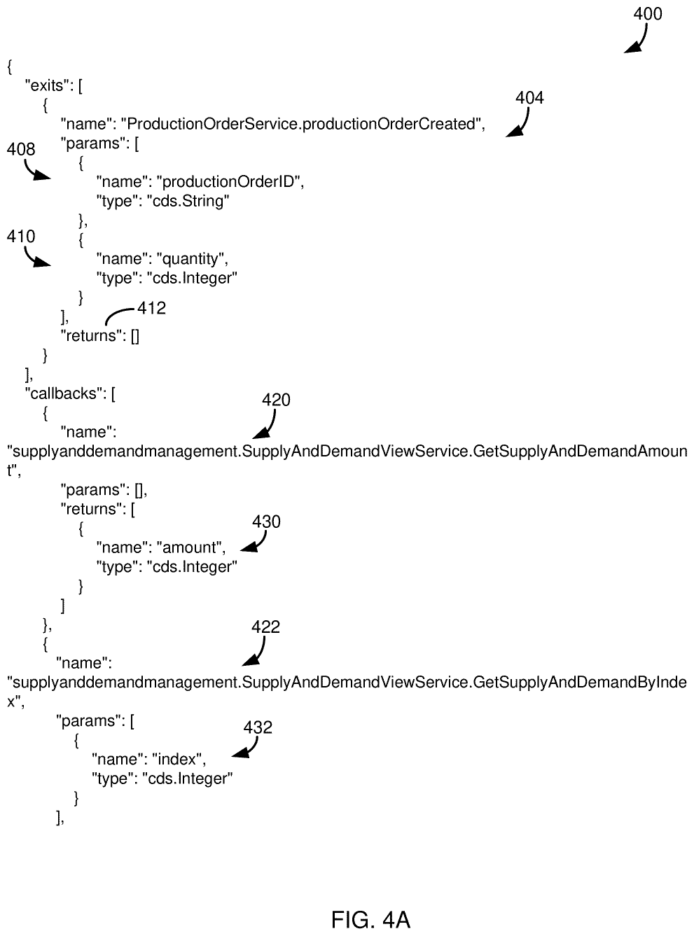

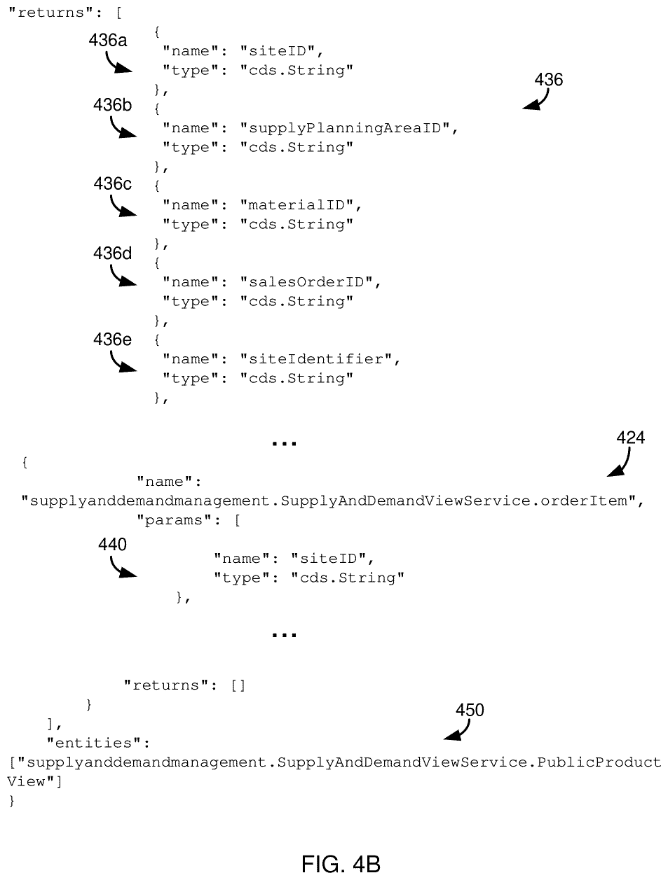

FIGS. 4-8 provide an example implementation of components of the code structure 300 of FIG. 3. In particular FIGS. 4A and 4B provide a general extension interface definition 400. In this case, with reference to FIG. 4A, the extension interface definition 400 specifies an exit 404, which is functionality that is called when a production order is created. The exit 404 includes two parameters 408, 410. The parameters 408, 410 correspond to, respectively, an identifier of the production order being created and a quantity of the item requested for production. In addition to specifying particular attributes/parameters, the exit 404 also provides data types that are associated with the attributes, such as indicting that the parameter 408 has a string datatype and the parameter 410 has an integer data type. Note that the exit 404 also has a “returns” section 412. The returns section 412 specifies what, if any, data is required to be provided by an exit implementation. In the specific example of the interface definition 400, the exit 404 does not require any information to be returned.

The extension interface definition 400 further specifies, with reference to FIGS. 4A and 4B, a plurality of callbacks 420, 422, 424. Callback 420 corresponds to a “read” request for information from the base application. That is, the callback 420 does not take any parameters, and includes a return 430 corresponding to a supply and demand “amount,” where the return also specifies that “amount” has an integer datatype.

Callback 422 can be used to obtain information about a particular supply and demand item, such as an order, using an index parameter 432 that is specified as having an integer datatype. The callback 422 includes a variety of return attributes 436, including return attributes of site ID 436a, a supply planning area identifier 436b, a material identifier 436c, a sales order identifier 436d, and site identifier 436e.

Only a portion of callback 424 is shown, where the callback can be used to cause an item to be ordered using the base application. In this case, the callback 424 includes multiple parameters, where only parameter 440 is shown for simplicity of presentation. In this case, the callback 424 does not provide any information back to an exit implementation that uses the callback. If desired, a return could be provided that indicates success or failure in a process of creating an order with the base application.

The interface definition 400 also includes a listing of particular entities that are available for use by an exit implementation. In this case, entity specification 450 specifies that a view (“PublicProductView”) is available to be used by an exit implementation. In some cases, additional files can be used to define operations that can be performed with an entity, such as a file that specifies how CRUD operations can be carried out on an entity. These types of “utility” files can be made available for use with multiple exits, and can serve as part of an extension development and execution framework.

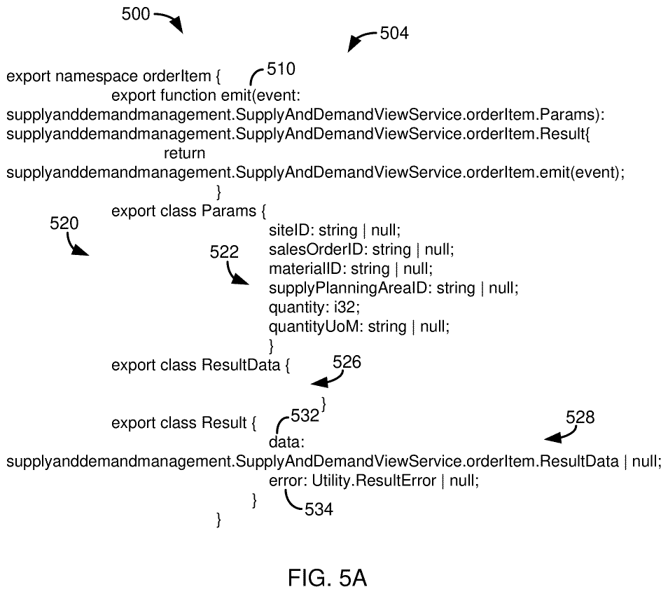

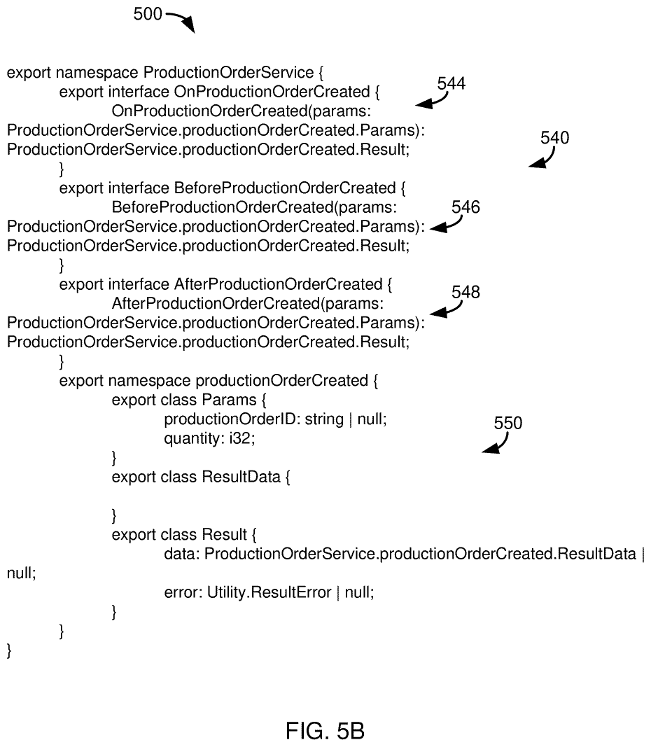

FIGS. 5A and 5B provide model information 500 corresponding to the interface 400, where the model information can correspond to the model 124 of FIG. 1, and the interface corresponds to the extension interface 120. That is, the interface definition 400 is defined with respect to the model information 500. In FIG. 5A, the model information 500 defines a namespace 504 (“orderItem”) that exposes functionality of the interface 400. The namespace can be used for organizing and grouping functionally related information or data.

A function 510 is defined that emits an event. For example, the function 510 can serve to trigger an exit implementation when an exit is reached during processing by the base application. The function 510 acts as a mediator between the base application and the extension runtime. For example, when the function 510 is called to emit an event, the corresponding implementation can be executed in the extension runtime.

As part of emitting an event performed by the function 510, code 520 exports a set of parameters 522 associated with the event, there the code defines the parameters, and their datatypes. These values are provided to the extension runtime for use by an implementation of the exit. As shown, in some cases the parameters are able to either accept a value in the specified datatype or a null value.

Optionally, code for an exit can specify a set of return information. The return information provides information back to the base application, such as data generated by the exit implementation or execution or status information, such as whether execution of the exit implemented succeeded, failed, completed with errors, etc.

As shown, a class 526 for attributes associated with data produced by the exit and provided by a return value is empty, which can indicate that the structure of the result data is defined elsewhere (such as in the interface 400). A class 528 for a result is shown as including an attribute 532 for result data or a null value, as well as an attribute 534 which can either provide an error message or have a null value. If data is returned by the execution of an extension implementation, the base application can use this data in subsequent processing.

In FIG. 5B, code 540 exports a namespace for a production order service. The namespace includes export statements 544, 546, 548 for interface methods for functionality that is performed, respectively, when a production order is created, before a production order is created, and after a production order is created. FIG. 5B also illustrates code 550 specifying additional details for the exported interface 544 for the creation of a production order. The code 550 provides namespace information describing parameters that are defined for the production order created interface method, corresponding to an exit of the base application, and information about results expected by the method.

The code in FIGS. 4A, 4B, 5A, and 5B illustrates that exits and callbacks can be defined in different files. For example, it may be beneficial to have more general functionality for an exit or callback specified in a more general file, like an interface definition or a model, while having more specific information specified in other files. For example, the code of FIGS. 5A and 5B does not define an “emit” function for the creation of a production order, but this information can be provided in another file, including in another file that provides further implementation details for the namespace.

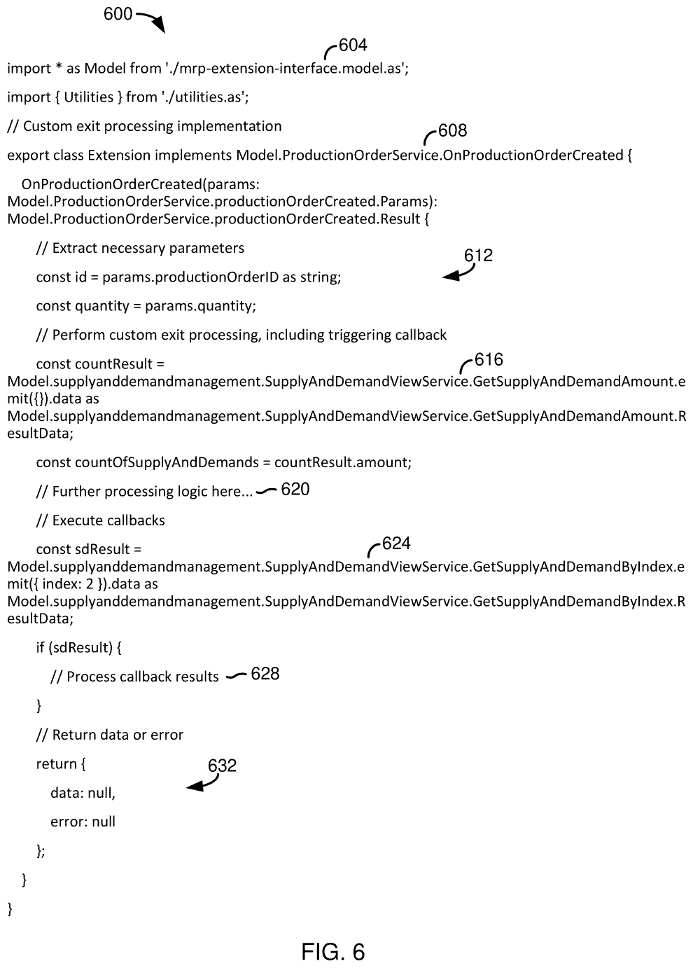

In FIG. 6, code 600 provides an implementation of the exit for processing to be performed when a production order is created, corresponding to the export statement 544. The code 600 includes a statement 604 that imports information from the model defined in the model definition 500. As part of the custom exit processing information for the extension, line 608 declares that the Extension class implements the exit 404 of the interface definition 400. Code 612 processes the parameters provided when the exit implementation is called. As part of the processing, code 616 triggers the “GetSupplyAndDemandAmount” callback. Additional custom processing logic can be carried out at code 620, before code 624 triggers another callback, “GetSupplyAndDemandByIndex.” The results of the callback are then processed using the custom processing of code 628. Finally, and optionally, results can be provided back to the base application using code 632.

While a base application can provide a model and interface that can be used in developing extensions, a given extension implementation need not implement all available exits, or use all available callbacks provided by the model and interface. Accordingly, an extension implementation can provide information, which can be used by a base application, including in configuration of the base application, regarding exits and callbacks that the extension implementation provides.

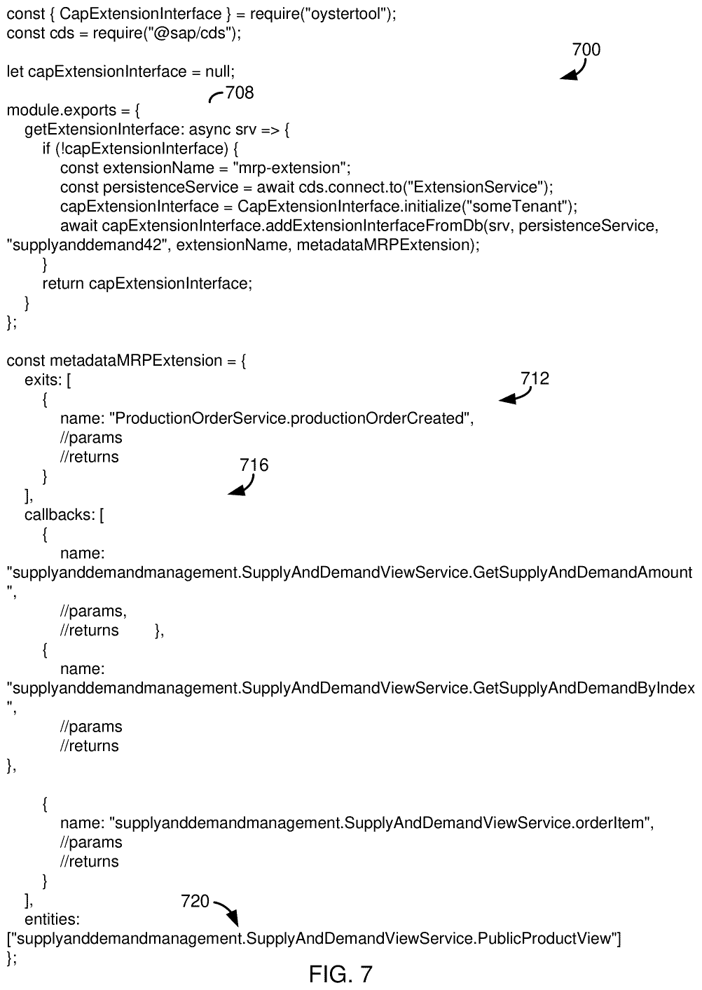

FIG. 7 provides example code 700 that provides this information. Code 708 provides a method, getExtensionInterface, that can be used to obtain information about the extension implementation. Code 712 indicates the exits that the extension implementation implements, while code 716 indicates the callbacks that the extension implementation uses. The details of the exits and callbacks is omitted from the code 712, 716 for clarity of presentation. The parameters and returns of the code 712, 716 would correspond to those defined for the exits and callbacks in the code for the model or the interface, as in FIGS. 4A, 4B, 5A, and 5B. Code 720 indicates what entities are used by the extension implementation.

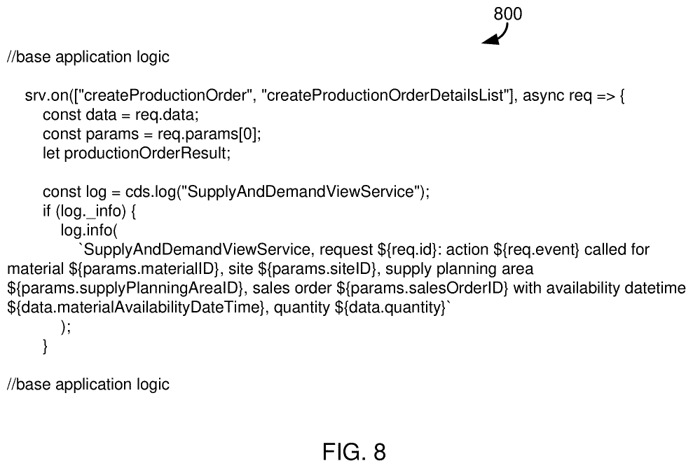

FIG. 8 illustrates example code 800 of the base application. The code 800 defines an event handler that operates when a production order is created. When the code 800 is executed during use of the base application, the event handler emits a trigger for the corresponding exit. The trigger is then used to cause execution of the exit implementation defined by the code 600 of FIG. 6.

### Example 6—Example Object-Event Extensions

While prior examples have described facilitating extension development, deployment, and execution using exits provided by a base application, disclosed techniques can be used with other types of hooks or customization points, including “exits” that are provided other than by base application functionality (or at least using triggers that are based on base application execution reaching a particular processing point).

As an example, software is very commonly implemented using object-oriented programming, where objects can often represent analog-world subject matter, such as an employee, an invoice, or a production order. Objects typically have predefined methods that allow users to easily perform tasks that would be expected for this subject matter, such as creating or modifying a purchase order, or validating data in an invoice.

Exits are often defined for applications for specific, anticipated use cases in a particular application use scenario. In order to facilitate the broader implementation of extension functionality, disclosed techniques can provide extension points that are more general in nature. For example, an application can provide exits corresponding to particular methods (some of which can be termed as “events”) for a data object, such as defining an exit for when a particular instance of an object is created, validated, etc. The specification and implementation of these exits, as well as any callbacks or data structures associated therewith, can be implemented in a similar manner as described in Examples 2-5.

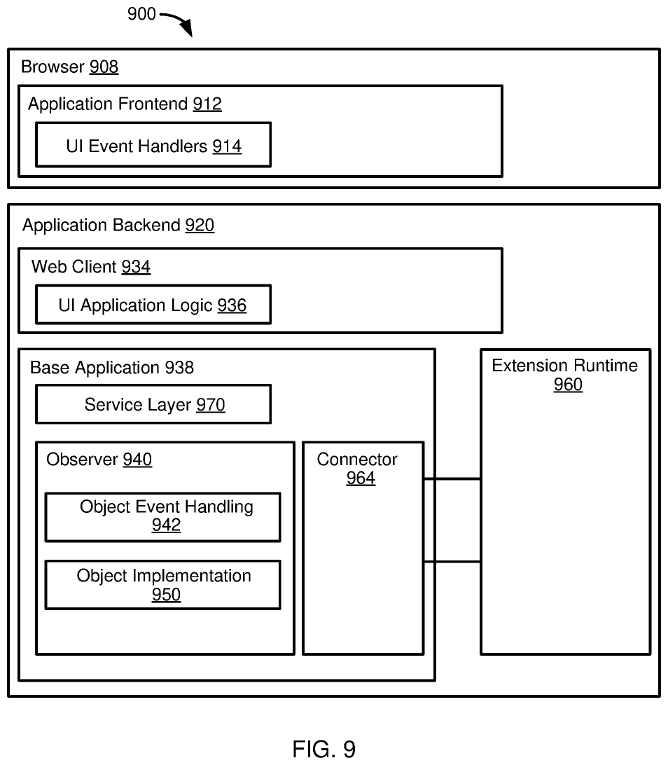

FIG. 9 illustrates an example computing environment 900 that provides for object-associated exits that can be implemented and used in an extension runtime. The computing environment 900 depicts a scenario where a client uses an application front end 912 of a browser 908 to interact with an application backend 920. This arrangement is just one way object-associated exits can be used/accessed. For example, in some cases, a user may be able to interact with applications associated with the application backend 920 directly, or at least in a manner that does not use the browser 908.

The application front end 912 includes user interface event handlers 914. The user interface event handlers 914 can be used to call functionality of the application backend 920. For example, an observer 940 of the application backend 920, part of a base application 938, can include an object event handling component 942 that receives calls from user interface application logic 936 of a web client 934. In turn, the object event handling component 942 interacts with an object implementation 950 (for example, method of an object that creates or validates an instance of the object).

The object event handing component 942 can determine if a user interface event is associated with an exit for which an extension implementation has been provided. If so, the exit implementation can be executed in an extension runtime 960, where the object event handling component 942 interacts with the extension runtime using an extension connector 964. The extension connector 964 can also interact with the extension runtime 960, such as in executing exit implementations for exits associated with base application functionality, as described in prior examples. Information provided by execution of an extension in the extension runtime 940 can be provided to a service layer 970 of the base application 938, where it can be processed, and, as appropriate, data provided by to the web client 934 and the application frontend 912.

### Example 7—Example Operations

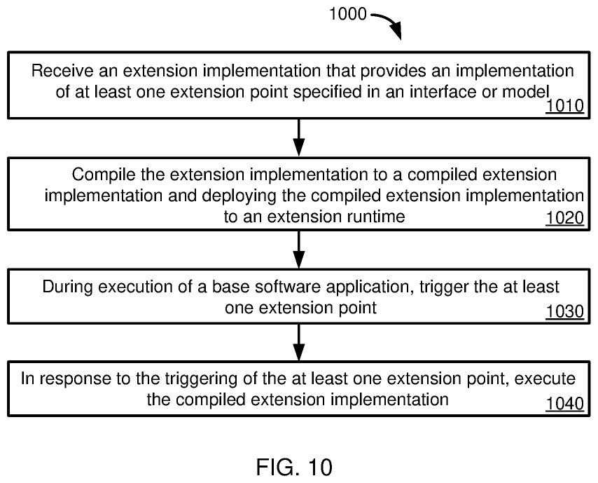

FIG. 10 is a flowchart of creating and executing an extension implementation in an extension runtime. An extension implementation is received at 1010 that provides an implementation of at least one extension point specified in an interface or model. At 1020, the extension implementation is compiled to provide a compiled extension implementation and the compiled extension implementation is deployed to an extension runtime. During execution of a base software application, at 1030, the at least one extension point is triggered. At 1040, in response to the triggering of the at least one extension point, the compiled extension implementation is executed.

### Example 8—Computing Systems

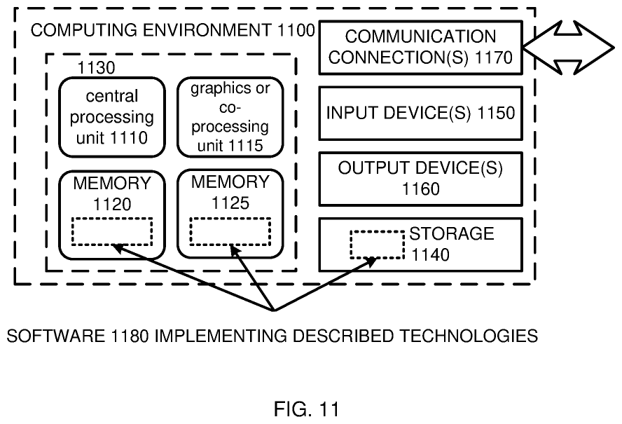

FIG. 11 depicts a generalized example of a suitable computing system 1100 in which the described innovations may be implemented. The computing system 1100 is not intended to suggest any limitation as to scope of use or functionality of the present disclosure, as the innovations may be implemented in diverse general-purpose or special-purpose computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing a database environment, and associated methods, described in Examples 1-7. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 may be removable or non-removable, and includes magnetic disks, magnetic tapes or cassettes, CD-ROMs, DVDs, or any other medium which can be used to store information in a non-transitory way, and which can be accessed within the computing system 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing system 1100. The output device(s) 1160 may be a display, printer, speaker, CD-writer, or another device that provides output from the computing system 1100.

The communication connection(s) 1170 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9—Cloud Computing Environment

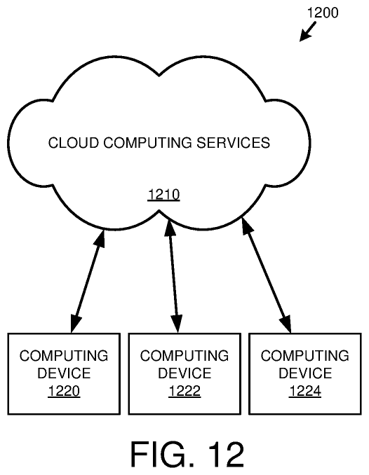

FIG. 12 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operators (e.g., data processing, data storage, and the like).

### Example 10—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 11, computer-readable storage media include memory 1120 and 1125, and storage 1140. The term computer-readable storage media does not include signals and carrier waves. In addition, the term computer-readable storage media does not include communication connections (e.g., 1170).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving an extension implementation that provides an implementation of at least one extension point specified in an interface or model;
compiling the extension implementation to a compiled extension implementation and deploying the compiled extension implementation to an extension runtime;
during execution of a base software application, triggering the at least one extension point; and
in response to the triggering of the at least one extension point, executing the compiled extension implementation.

2. The computing system of claim 1, the operations further comprising:
compiling the model to provide a compiled model; and
deploying the compiled model to the extension runtime, wherein the compiled extension implementation accesses the compiled model during execution of the compiled extension implementation.

3. The computing system of claim 1, wherein the interface or model provides at least one function of the base software application that can be called by an extension implementation and the extension implementation comprises a call to the at least one function.

4. The computing system of claim 1, wherein the extension runtime is integrated with a runtime of the base software application.

5. The computing system of claim 1, wherein the extension runtime is separate from a runtime of the base software application.

6. The computing system of claim 1, wherein the model specifies one or more data structures and the exit implementation accesses at least one data structure of the one or more data structures.

7. The computing system of claim 1, the operations further comprising:
generating metadata describing the extension implementation; and
configuring the base software application to use the extension implementation based at least in part on the metadata.

8. The computing system of claim 1, wherein the extension runtime is a sandboxed environment.

9. The computing system of claim 1, wherein the extension implementation is compiled to a portable binary format.

10. The computing system of claim 9, wherein the portable binary format is WebAssembly.

11. The computing system of claim 1, wherein executing the compiled extension implementation comprises instantiating the exit implementation to provide an instantiated exit implementation, the operations further comprising:
caching the instantiated exit implementation.

12. The computing system of claim 1, wherein the compiled extension implementation is used for processing extension point triggers for multiple clients.

13. The computing system of claim 1, wherein executing the compiled extension implementation comprises:
from the base software application, sending to an extension proxy of the execution runtime a call to execute the compiled extension implementation; and
with the extension proxy, calling the compiled exit implementation.

14. The computing system of claim 13, the operations further comprising:
with the extension proxy, translating the call from the base software application to a format used by the extension runtime.

15. The computing system of claim 14, wherein translating the call comprises converting a parameter value from a first datatype to a second datatype.

16. The computing system of claim 1, the operations further comprising:
in response to the triggering of the at least one extension point, sending a message to an extension connector to execute the compiled extension implementation.

17. The computing system of claim 16, the operations further comprising:
by the extension connector, storing a context for the message.

18. The computing system of claim 1, the operations further comprising:
in response to the triggering of the at least one extension point, determining a version of the extension interface to be executed.

19. A method, implemented in a computing system comprising at least one hardware processor and at least one memory coupled to the at least one hardware processor, the method comprising:
receiving an extension implementation that provides an implementation of at least one extension point specified in an interface or model;
compiling the extension implementation to a compiled extension implementation and deploying the compiled extension implementation to an extension runtime;
during execution of a base software application, triggering the at least one extension point; and
in response to the triggering of the at least one extension point, executing the compiled extension implementation.

20. One or more computer-readable storage media comprising:
computer-executable instructions that, when executed by a computing system comprising at least one hardware processor and at least one memory coupled to the at least one hardware processor, cause the computing system to receive an extension implementation that provides an implementation of at least one extension point specified in an interface or model;
computer-executable instructions that, when executed by the computing system, cause the computing system to compile the extension implementation to a compiled extension implementation and deploying the compiled extension implementation to an extension runtime;
computer-executable instructions that, when executed by the computing system, cause the computing system to, during execution of a base software application, trigger the at least one extension point; and
computer-executable instructions that, when executed by the computing system, cause the computing system to, in response to the triggering of the at least one extension point, execute the compiled extension implementation.
